(19) United States
(12) Patent Application Publication
(10) Pub. No.: US 2016/0325928 A1
(43) Pub. Date: Nov. 10, 2016

(54) A LOCKING APPARATUS AND A SECURING MECHANISM THEREIN

(71) Applicant: ISRAEL AEROSPACE INDUSTRIES LTD., Lod (IL)

(72) Inventors: Hanan Lepek, Jerusalem (IL); Yoav Herzig, Ein Sarid (IL); Omer Einav, Moshav Kfar Monash (IL); Doron Shabanov, Zur Igal (IL)

(21) Appl. No.: 15/112,260

(22) PCT Filed: Jan. 18, 2015
(86) PCT No.: PCT/IL2015/050056

§ 371 Date: Jul. 18, 2016

(30) Foreign Application Priority Data
Jan. 20, 2014 (IL) 230539

(51) Int. Cl. B65D 90/00; B65G 63/00; F16B 2/18; F16B 2/14; F16B 2/04

(52) U.S. Cl. CPC B65D 90/0006; F16B 2/14; F16B 2/04; F16B 2/18; B65G 63/004

(57) ABSTRACT

A securing mechanism for securing thereto a load. The securing mechanism comprises a locking member having at least one planner with a peripheral shape, a cam follower mechanism having a follower with a load facing end and being configured to translate a linear displacement along an axis being perpendicular to said load facing end to a rotational movement thereof about said axis, and being so disposed relative to said locking member such that said rotational movement thereof sequentially shifts said locking member between a released position in which at least one dimension of said peripheral shape has a first size and a secured position in which said dimension has a second size, said second size being larger than said first size.

### TECHNOLOGICAL FIELD

The presently disclosed subject matter relates to a locking apparatus having a securing mechanism therein, in general, and in particular to a locking apparatus for freight containers.

### BACKGROUND

Shipping freight via containers remains a cost effective way transport goods globally. Typically, many such containers are transported on a marine vessel and unloaded at a port. The containers are then stored at or near the port, until trucks arrive to transport each container to its intended location. Alternatively, in the case of transshipment the container is unloaded to a port from one vessel, stored at the port for a period of time and loaded back to another vessel.

Between the time the containers are unloaded from the marine vessel and transported by the truck, the containers are stored. The containers are typically stacked in a container yard. The height of each stack can be limited by the weight of the containers and their strength, the type of equipment being used for lifting each container and by other parameters of the containers, although usually they do not exceed six containers.

Since different containers are stored in the port for different period of times the extraction thereof is not carried out at the same time. Thus, in this case a specific container must be retrieved from a stack of container. Typically it is desirable to store a group of containers which are interceded to be extracted from the storage area at the same time, for example if all the containers in the group have the same destination. However, in practice, containers arrive somehow randomly and relevant data, like weight information, is not always given at that time, and thus, they are stored somewhat randomly.

Retrieval of each container involves identifying the location of a desired container among the stacks, and, if necessary, relocating containers which are above it in order to retrieve the desired container for placement on a truck.

WO 2011/104716 discloses a method of transferring a plurality of containers to storage. the method comprises providing at least one multi-level structure with an elevator configured to receive and transport one or more containers thereupon and being configured to ascend and descend to a predetermined level, each of the levels comprising a plurality of bays being sized to receive and store therein one of the containers; providing a plurality of unmanned autonomous guided vehicles (AGV) configured to perform forward/backward and sideways movements and to receive a container thereupon; receiving each of the containers on a receiving AGV (rAGV) of the AGVs; and positioning the rAGV with the container received thereby in a target bay on a target level of the structure.

There are known method and devices for clamping and securing containers. U.S. Pat. No. 8,177,463 for example, discloses a system for locking and unlocking containers to transport modes and other containers comprises an actuating unit in an upper corner fitting of a container, a mechanical connecting mechanism connected to the actuating unit, and guides to route the connecting mechanism from the actuating unit to a rotatable locking leg housed in a lower corner fitting of the container. The twist lock of a lifting spreader engages the upper corner fitting of a container, urging the actuating unit. The connecting mechanism is in turn urged thereby causing the locking leg to rotate.

US20030041421 discloses a releasable semi-automatic clamping device for holding down a corner fitting of a container to an underlying support, such as a load platform of a road or rail vehicle, in which the device enters the corner fitting via a lower entrance aperture upon relative closing movement between the support and the corner fitting. The device comprises a clamping head which is rotatable between a clamping position and a release position, and which is usually biased towards the clamping position by a biasing means.

EP 0694018 discloses a clamp-on container module which is adapted to be mounted on one end of an I.S.O. container having upper and lower corner lift fittings, said module having clamps which are engageable with at least the upper corner lift fittings of the container, in which each said clamp comprises: a mounting bracket securable to said module; a shank mounted in said bracket for relative axial movement between a clamping position and a release position; a clamping head mounted on one end of said shank and adapted to cooperate with a respective corner fitting, said head being angularly adjustable about the axis of the shank between an entry position in which the head can enter the respective corner fitting, and a captive position in which the head is prevented from withdrawal from the fitting; an actuator lever operable to rotate the head between the entry position and the captive position; and, a lever-operated ratchet mechanism operable to move the shank axially to the clamping position, after the head has been rotated to the captive position, in order to clamp the head to the corner fitting, and thereby to clamp an adjacent part of the module to the container end.

### GENERAL DESCRIPTION

According to one aspect of the presently disclosed subject matter there is provided a securing mechanism for securing thereto a load, the securing mechanism comprising a locking member having at least one planner with a peripheral shape, a cam follower mechanism having a follower with a load facing end and being configured to translate a linear displacement along an axis being perpendicular to the load facing end to a rotational movement thereof about the axis. The follower is so disposed relative to the locking member such that the rotational movement thereof sequentially shifts the locking member between a released position in which at least one dimension of the peripheral shape has a first size and a secured position in which the dimension has a second size, the second size being larger than the first size.

The locking member can include a pair of pivoting securing latches each having an engaging portion wherein the planner is a planner encircling the engaging portion of the securing latches together. The engaging portion can be a shoulder engaging portion.

The locking member can further include a housing and the securing latches can be pivotally mounted in the housing. In the secured position the securing latches are configured to be pivoted away from one another such that the shoulder engaging portions are laterally displaced thereby increasing the size of the planner encircling the engaging portion.

The locking member can further include a retracting mechanism, configured to urge the shoulder engaging portions towards one another such that least a portion of the follower can be slidably mounted within the housing.

The follower can be a cylindrical member having at least one guide defining a slanted path along a portion of the circumference thereof and the housing can include a cam segment defined therein configured to slide along the slanted path such that in response to the linear displacement the follower is rotated.

The cylindrical member can include a first guide defined on one end thereof and a second guide opposingly defined on the other end thereof, and a cylindrical surface therebetween. Each of the first guide and second guide can include a plurality of slanted steps protruding from the cylindrical surface and defined about the circumference thereof. Each one of the slanted step can terminate in a longitudinal protrusion. The first guide can be disposed with respect to the second guide such that each of the slanted steps thereof is shifted with respect to the slanted steps defined of the second guide.

Each of the first guide and second guide can include 4 slanted steps and 4 longitudinal protrusions alternately defined along the circumference of the cylindrical surface.

The housing can include a compartment configured for slidably holding the follower therein such that the load facing end protrudes outside the housing. The compartment can further include a depression at the top portion thereof configured for holding a biasing spring for biasing the follower in the direction towards the load facing end. The compartment can include a first cam segment and a second cam segment each of which longitudinally protrudes one above the other from an inner surface of thereof along the length thereof.

The compartment can further include a stop member transversely disposed between the first cam segment and the second cam segment. The compartment can be defined slightly laterally shifted with respect to the securing latches.

The follower can include an ellipse plate mounted thereon and having a major axis extending along the large diameter thereof and a minor axis extending along the small diameter thereof.

The ellipse plate can be mounted on the follower such that the orientation of the minor axis and the major axis is changed in response to a rotational movement of the follower. The ellipse plate can be configured for 90° rotation in response to an upward displacement of the follower followed by a downward retraction with respect to the housing. The large diameter of the ellipse plate can be configured such that the ellipse plate urges the securing latches away from one another when the major axis extends along a line disposed therebetween thereby shifting the locking member to the secured position.

According to a further aspect of the presently discloses subject matter there is provided a locking apparatus for securing a load to a structure the apparatus comprising a housing mountable to a structure, and having a retractable load facing end coupled to a locking member having at least one planner with a peripheral shape. The load facing end is configured for sequentially shifting the locking member between a released position and a secured position in response to an upward displacement thereof followed by a downward retraction with respect to the housing. In the released position at least one dimension of the peripheral shape has a first size and in the secured position the dimension has a second size. The retractable member can include a cam follower mechanism.

The locking member can include an ellipse plate and at least one securing latch pivotally mounted to the housing and having an engaging portion wherein the planner is a planner encircling the engaging portion and the ellipse plate of the securing latch together. The engaging portion can be a shoulder engaging portion. The locking member can include two securing latch pivotally mounted to the housing and wherein in the secured position the securing latches are configured to be pivoted away from one another such that the shoulder engaging portions are laterally displaced thereby increasing the size of the planner encircling the engaging portion. The locking member can further include a retracting mechanism, configured to urge the securing latches towards one another. At least a portion of the follower is slidably mounted within the housing.

The follower can be a cylindrical member having at least one guide defining a slanted path along a portion of the circumference thereof and the housing includes a cam segment defined therein configured to slide along the slanted path such that in response to the linear displacement the follower is rotated.

The compartment can include a depression at the top portion thereof configured for holding a biasing spring for biasing the follower in the direction said downward retraction. The compartment can be defined slightly laterally shifted with respect to the securing latches, such that the securing latches can be introduced into a depression while the load facing end can be engaged by a the wall of the depression.

The load facing end can be an ellipse plate mounted having a major axis extending along the large diameter thereof and a minor axis extending along the small diameter thereof. The ellipse plate is mounted on the follower such that the orientation of the minor axis and the major axis is changed in response to a rotational movement of the follower. The ellipse plate is configured for 90° rotation in response to the upward displacement thereof followed by the downward retraction.

According to yet a further aspect of the presently discloses subject matter there is provided a locking assembly comprising a body having a depression and a shoulder portion defined therein, and a locking apparatus for securing to the body.

The locking apparatus includes a locking member having at least one planner with a peripheral shape; and a cam follower mechanism having a follower with a load facing end and being configured to translate a linear displacement along an axis being perpendicular to the load facing end to a rotational movement thereof about the axis, and being so disposed relative to the locking member such that the rotational movement thereof sequentially shifts the locking member between a secured position in which the locking member securely engages the shoulder portion and a released position in which the locking member disengages the shoulder portion. The depression can be configured to allow introducing therein the locking members only in the released position thereof.

### BRIEF DESCRIPTION OF THE DRAWINGS

In order to better understand the subject matter that is disclosed herein and to exemplify how it may be carried out in practice, embodiments will now be described, by way of non-limiting example only, with reference to the accompanying drawings, in which:

FIG. 1A is a side perspective view of the securing mechanism according to an example of the presently disclosed subject matter, mounted thereon;

FIG. 1B is an exploded view of the securing mechanism of FIG. 1A;

FIG. 2 is a side sectional view of the housing of the securing mechanism of FIG. 1A;

FIG. 3 is a partial transparent view of the securing mechanism of FIG. 1A in one step during the securing process of a container;

FIG. 4 is a partial transparent view of the securing mechanism of FIG. 1A in another step during the securing process of a container;

FIG. 5 is a partial transparent view of the securing mechanism of FIG. 1A in another step during the securing process of a container;

FIG. 6 is a partial transparent view of the securing mechanism of FIG. 1A in another step during the securing process of a container;

FIG. 7 is a partial transparent view of the securing mechanism of FIG. 1A in another step during the securing process of a container;

FIG. 8 is a partial transparent view of the securing mechanism of FIG. 1A in another step during the securing process of a container;

FIG. 9 is a partial transparent view of the securing mechanism of FIG. 1A in one step during the releasing process of a container;

FIG. 10 is a partial transparent view of the securing mechanism of FIG. 1A in another step during the releasing process of a container;

FIG. 11 is a partial transparent view of the securing mechanism of FIG. 1A in another step during the releasing process of a container;

FIG. 12 is a partial transparent view of the securing mechanism of FIG. 1A in another step during the releasing process of a container; and

FIG. 13 is a partial transparent view of the securing mechanism of FIG. 1A in another step during the releasing process of a container.

### DETAILED DESCRIPTION OF EMBODIMENTS

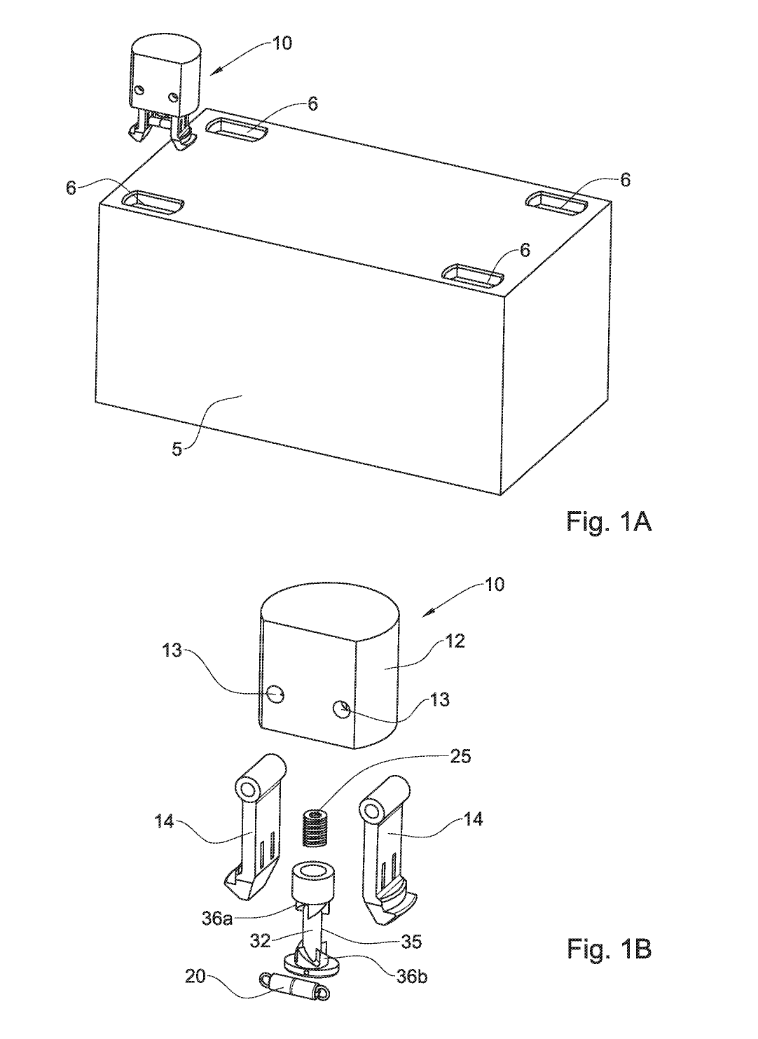

FIGS. 1A and 1B illustrate a securing mechanism 10 for securing thereof to a load 5, here illustrated as a freight container. The securing mechanism 10 can be mounted on a structure, a ceiling for example, such that the container 5 can be secured thereto and suspended from the ceiling thereby. The securing mechanism 10 is configured to be secured to a corner fitting 6 of the container 5, having a depression 8 configured with an opening 8a and a shoulder portion 9.

The securing mechanism 10 includes a housing 12 having a locking member here illustrated as a pair of securing latches 14 pivotally mounted thereto, each having a shoulder engaging portion 16 configured for engaging the shoulder portion 9 of the corner fitting 6. According to the illustrated example, each one of the securing latches 14 is mounted on a hinge 18 disposed inside the housing 12, such that when the securing latches are pivoted away from one another the shoulder engaging portions 16 are laterally displaced. The lateral displacement of the shoulder engaging portions 16 allows the latter to be selectively disposed in a secured position in which each of the shoulder engaging portions 16 securely engages a shoulder portion 9 of the container's corner fitting 6, and a released position in which the shoulder engaging portions 16 can be introduced into the depression 8 or removed therefrom. The two securing latches 14 further include a latches spring 20, or other retracting mechanism, mounted therebetween and configured to urge the two shoulder engaging portion 16 towards one another.

It is appreciated that other locking members having at least one planner with a peripheral shape such that in a released position at least one dimension of the peripheral shape has a first size smaller than the size of at least one dimension of the opening 8a thereby allowing the locking member to be introduced into the depression 8, and a secured position in which the dimension of the peripheral shape of the locking member has a second size larger than the first size, such that the locking member engages the shoulder portion inside the depression.

According to the illustrated example, the disposition of the securing latches 14 and the shoulder engaging portions 16 in the secured position and in the released position is configured in accordance with the size of the opening 8a and the shoulder portion 9 defined in the corner fitting 6. That is to say, the disposition of the shoulder engaging portions 16 in the released position is such that an imaginary encircling diameter of both of them is smaller than the diameter of the opening 8a Similarly, the disposition of the shoulder engaging portions 16 in the secured position is such that the imaginary encircling diameter of both of them together allows secure engagement with the shoulder portion 9.

The securing mechanism 10 further includes a cam follower mechanism 30 having a follower 32 slidably mounted within the housing 12 and configured to translate a linear displacement to a rotational movement. According to an example of the presently disclosed subject matter the follower 32 is a cylindrical member having a first guide 36a defined on one end thereof and a second guide 36b opposingly defined on the other end thereof, and a cylindrical surface 35 therebetween. Each of the first and second guides 36a and 36b include a plurality of slanted steps 38a and 38b respectively, protruding from the cylindrical surface 35 and defined about the circumference thereof. The slanted steps 38a and 38b are slanted with respect to the longitudinal direction of the cylindrical member and the circumference thereof. Each slanted step 38a and 38b terminates in a longitudinal protrusion 40a and 40b, respectively, defined along a portion of the length of the cylindrical member.

The first guide 36a is disposed with respect to the second guide 36b such that each slanted step 38a thereof is shifted with respect to the slanted step 38b of the second guide 36b. According to the illustrated example, the longitudinal protrusion 40b of the second guide 36b is disposed substantially opposite the middle of the slanted step 38 of the first guide 36a.

For sake of simplicity the following description is made in reference to the first guide 36a, the description however applies to the second guide 36b and the various elements thereof, as well.

According to an example, the first guide 36a includes 4 slanted steps 38a and 4 longitudinal protrusions 40a alternately defined along the circumference of the cylindrical surface 35. Each slanted step 36a starts at one end of the longitudinal protrusions 40a and terminates at the second end of an adjacent longitudinal protrusion 40a. This way, the guide 36a defines a path along the circumference of the cylindrical member 34 which includes 4 segments each having a longitudinal section and a slanted section. As described herein below each of these segments corresponds to one step in the cam follower mechanism 30.

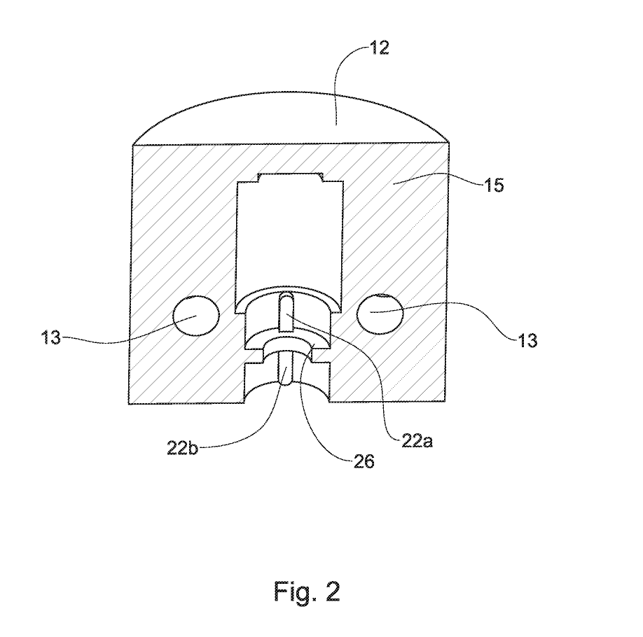

Reference is now made to FIG. 2, according to an example, the housing 12 includes a pair of bores 13 for holding hinges 18 about which the pair or securing latches 14 are pivoted. The housing 12 further includes a compartment 15 configured for slidably holding the follower 32 therein, such a load facing end of the follower protrudes outside the housing. The compartment 15 includes a depression 17 at the top portion thereof configured for holding a biasing spring 25 for biasing the follower 32 downwardly and outside the housing. The compartment 15 further includes a first and a second cam segment 22a and 22b each of which longitudinally protrudes one above the other from an inner surface of the compartment along the length thereof. According to an example of the presently disclosed subject matter, a stop member 26 is transversely disposed between the cam segments 22a and 22b, the purpose of which will be discussed hereinafter.

According to the illustrated example, the compartment 15 is defined slightly laterally shifted with respect to the securing latches 14, such that, as discussed hereinafter, when the shoulder engaging portions 16 are introduced into the depression 9 of the corner fitting 6, the bottom of the follower 32 bears against the top surface of the container 5.

The first and second cam segments 22a and 22b are configured to slide along the paths formed by the first and second guides 36a and 36b in an alternately fashion during longitudinal displacement of the follower 32. That is to say, when the follower 32 is displaced towards the biasing spring 25, against the force thereof, the first cam segment 22a slides along the length of the cylindrical surface 35 until the end thereof engages the slanted step 38a of the first guide 36a. The follower 32 can be further displaced until the first cam segment 22a engages the longitudinal protrusions 40a of the first guide 36a, which serves as a stop member. It is appreciated that due to the fact that the slanted step 38a is defined along the circumference of the cylindrical member 34, displacement of the follower 32 while the cam segment 22a bears against the slanted step 38a urges a rotational displacement of the follower.

When the follower 32 is displaced away from the biasing spring 25, for example under the force applied thereby, the second cam segment 22b slides along the length of the cylindrical surface 35 until the end thereof engages the slanted steps 38b of the second guide 36b. The follower 32 can be further displaced until the second cam segment 22b engages the longitudinal protrusions 40b of the second guide 36b, which serves as a stop member. In this case, displacement of the follower 32 while the cam segment 22b bears against the slanted steps 38b urges a rotational displacement of the follower.

It is appreciated that the direction of the rotational displacement of the follower 32 is determined in accordance with the slanting direction of the slanted steps 38a and 38b. That is to say, if the follower 32 is vertically disposed, it is urged to rotate counterclockwise (with respect to the bottom portion thereof) when being linearly displaced while the cam bears against a slanted portion having a left to right sloped.

According to the illustrated example, both slanted step 38a and 38b are defined such that the slanted portion extends from left to right, while the right side is defined towards the end of the follower.

As indicated above, the longitudinal displacement of the follower 32 can be further stopped by the stop member 26 defined in the housing. The stop member 26 can be disposed such that when the follower 32 is displaced towards the spring 25 as the first cam segment 22a engages the longitudinal protrusions 40a the stop member 26 bears against the ends of the longitudinal protrusions 40a thereby stopping the displacement of the follower towards the biasing spring 26.

Similarly, The stop member 26 can be disposed such that when the follower 32 is displaced away from the spring 25, as second cam segment 22b engages the longitudinal protrusions 40b, the stop member 26 bears against the ends of the longitudinal protrusions 40b thereby stopping the displacement of the follower towards the biasing spring 26.

The follower 32 further includes an ellipse plate 45 which can be mounted at the bottom of the first guide 36a. The ellipse plate 45 which defines a load facing end of the follower, includes a major axis 45a extending along the large diameter thereof and a minor axis 45b extending along the small diameter thereof. The ellipse plate 45 is mounted on the follower 32 such that the orientation of the minor and major axes 45a and 45b is changed in response to rotation of the follower 32.

The ellipse plate can be otherwise mounted about the follower, such that one side thereof extends along a smaller diameter while the other side thereof extends along a large diameter.

As discussed hereinabove, in the illustrated example, the first guide 36a of the follower 32 includes 4 pairs of slanted step 38a and longitudinal protrusion 40a, each corresponding to one rotational step of the follower Similarly, the second guide 36b of the follower 32 includes 4 pairs of slanted step 38b and longitudinal protrusion 40b, each corresponding to another rotational step of the follower. Accordingly, each rotational step can be configured to rotate the follower in 45°.

Following a single step of the follower 32 one of the first or second cams 22a or 22b bears against the respective longitudinal protrusions 40a or 40b thereby stopping the displacement of the follower 32. Thus, linear displacement of the follower 32 in the opposite direction will urge the latter to rotate in 45° in the same direction. Accordingly, the ellipse plate 45 can be 90° rotated by linearly displacing the follower 32 in one direction and then and the opposite direction. According to the illustrated example 90° rotation of the ellipse plate 45 shifts the orientation thereof with respect to the shoulder engaging portions 16 from the minor and major axes 45a and 45b.

As indicated hereinabove, according to the illustrated example the securing mechanism 10 can be mounted to a structure, such as a ceiling, so as to allow securing thereto an object having a member engagable with the shoulder engaging portion 16.

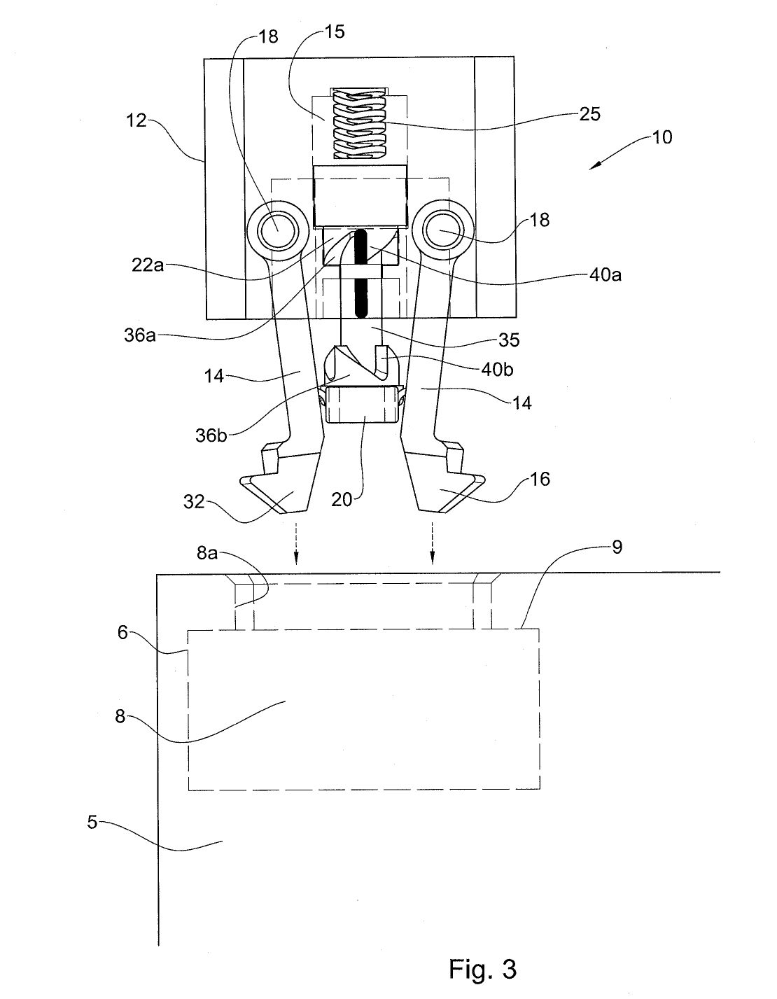

Reference is now made to FIGS. 3 through 9, when it is desired to secure a container 5, having a corner fitting 6 and a shoulder portion 9 defined therein, to the ceiling of a structure, the securing mechanism 10 can be mounted to the ceiling.

For the sake of simplicity portions of the housing 12 of the securing mechanism 10 is illustrated here in a transparent view denoted by dashed lines.

In the initial position, illustrated in FIG. 3, the securing mechanism 10 is in its released position wherein the securing latches 14 are urged towards one another by the spring 20 and are so disposed with respect to the depression 8 of the corner fitting 6 such that at least the shoulder engaging portions 16 can enter through the opening 8a thereof. In this position, the follower 32 is in its lowermost position with respect to the housing 12 and is urged to remain in this position by biasing spring 25. The first cam 22a in this position bears against the first guide 36a on one of the longitudinal protrusions 40a thereof. The ellipse plate 45 in this position is so oriented such that the minor axis 45b thereof extends along a line between the two shoulder engaging portions 16, while the major axis 45a thereof extends perpendicularly thereto.

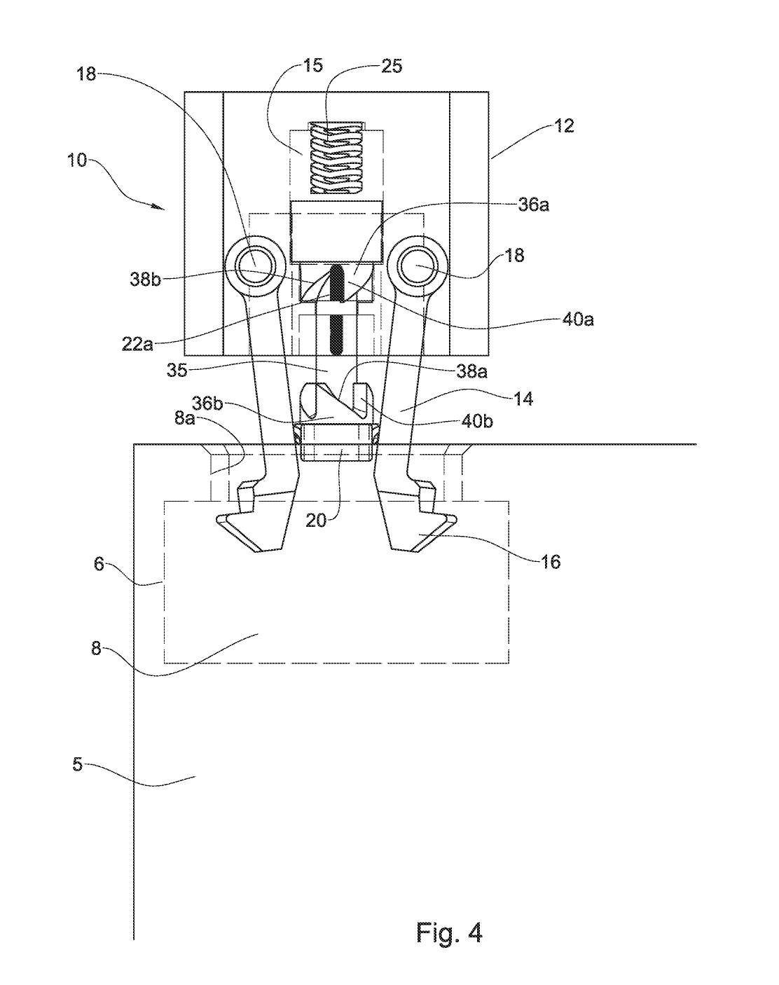

As shown in FIG. 4, the container 5 can be disposed such that the opening 8a of the corner fitting 6 is aligned with the securing latches 1. The container 5 can then be pushed upwardly until at least the shoulder engaging portions 16 are disposed inside the depression 8. Since the shoulder engaging portions 16 are in the released position thereof, the encircling diameter thereof is smaller than that of the opening 8a. Thus the shoulder engaging portions 16 can be introduced into the depression 8, and can disposed therein such that each shoulder engaging portion is disposed adjacent the respective shoulder portions 9.

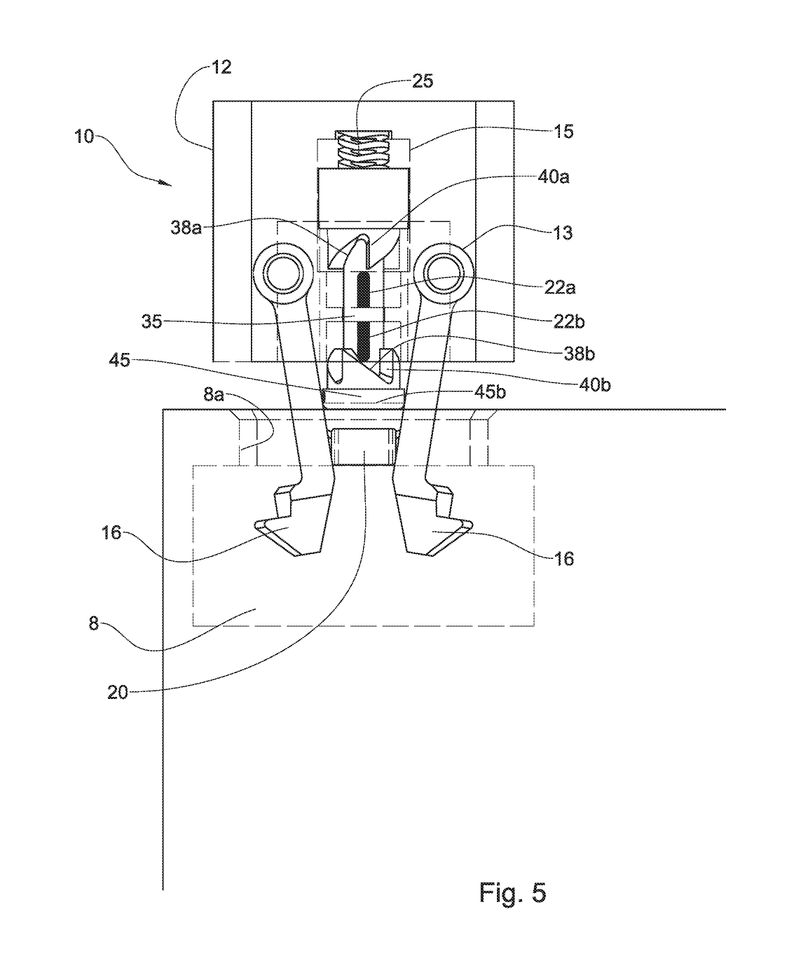

Refereeing now to FIG. 5, further pushing the container 5 upwardly, urges the container's upper face to engage the ellipse plate 45, this is due to the fact the compartment 15 of the housing 12 and hence the follower 32 and the ellipse plate 45 mounted on the bottom thereof are defined slightly laterally shifted with respect to the securing latches 14. Thus, when the shoulder engaging portions 16 are introduced into the depression 9 of the corner fitting, the ellipse plate 45 bears against the surface of the container 5 and consequently the follower 32 is pushed upwardly against the force of the spring 25.

As the follower 32 is displaced upwardly, the first cam 22a disengages the first guide 36a and the longitudinal protrusions 40a thereof, following which the second cam 22b engages one of the slanted steps 38b of the second guide 36b. As explained herein above, the second guide 36b is disposed with respect to the second guide 36b such that each slanted step 38a thereof is shifted with respect to the slanted portion 38b of the second guide 36b. Thus, as illustrated in FIG. 5, when the follower 32 is upwardly displaced the second cam 22b engages the slanted step 38b being disposed substantially across the longitudinal protrusions 40a of the first guide 36a.

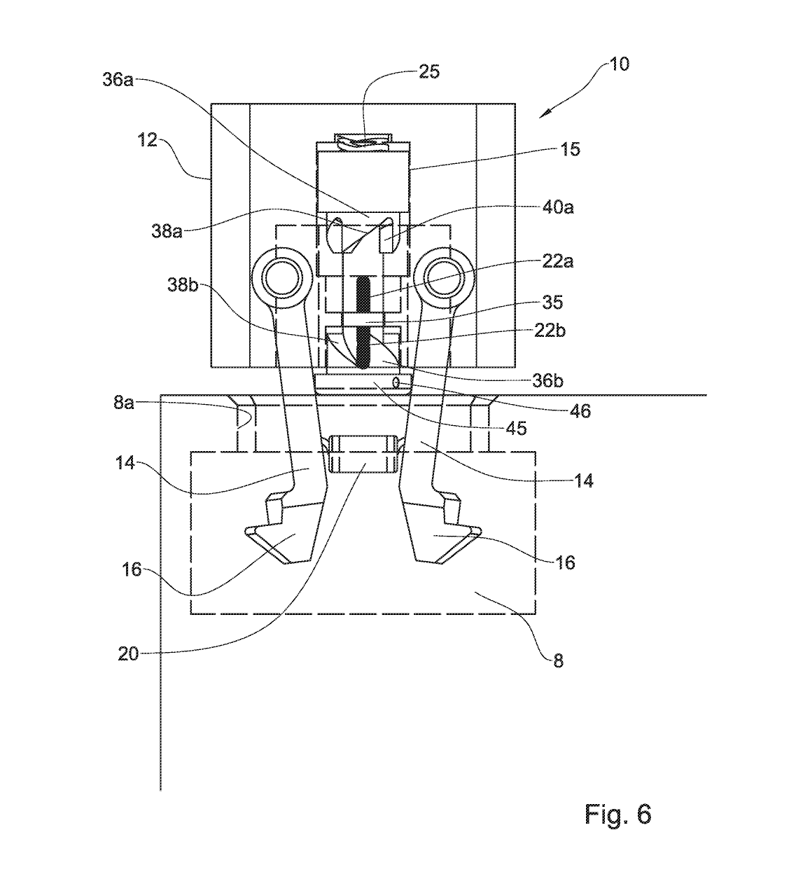

As shown in FIG. 6, further upward displacement of the container 5, further displaces the follower 32 upwardly, the engagement of the second cam 22b with the slanted step 38b urges the follower to rotate in the opposite direction of the slanting direction, illustrated here as a leftwards rotation. In this position, the rotation of the follower 32 causes the rotation of the ellipse plate 45, thus upon the completion of this step, i.e. when the second cam 22b is disposed at the end of the slanted step 38b engaging the longitudinal protrusions 40b, the ellipse plate 45 is rotated in 45°.

In order to allow the user to identify the disposition of the ellipse plate 45, an indication, such as a rounded mark 46, provided on a location about the circumference thereof indicates the disposition of the major axis 45a and the minor axis 45b with respect to the engaging portions 16. According to the illustrated example, the indication 46 is coaxially defined with the minor axis 45b.

In this position, the follower 32 is at its uppermost position with respect to the housing 12, and the spring 25 is in its maximum retracted state, thus the container 5 cannot be further upwardly displaced. The shoulder engaging portions 16, in this position, are located below the shoulder portion 9 of the depression 8.

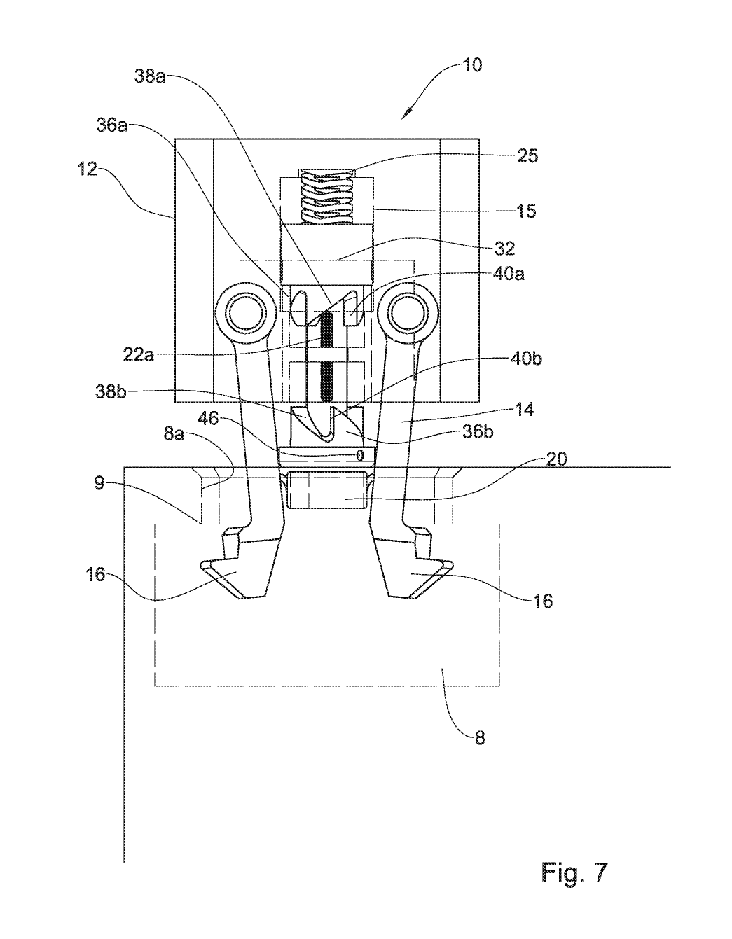

Attention is now drawn to FIG. 7, the container 5 can be slightly lowered such that the follower 32 can be displaced downwardly being urged under the forces of the spring 25. Thus, the second cam 22b disengages the second guide 36b and the longitudinal protrusions 40b thereof, following which the first cam 22a engages one of the slanted steps 38b of the first guide 36a.

Similar to the explanation herein above, with respect to FIG. 5, the slanted step 38a of the first guide 36a is shifted with respect to the slanted portion 38b of the second guide 36b. Thus, at this position, the first cam 22a engages the slanted step 38a being disposed substantially across the longitudinal protrusions 40b of the second guide 36b.

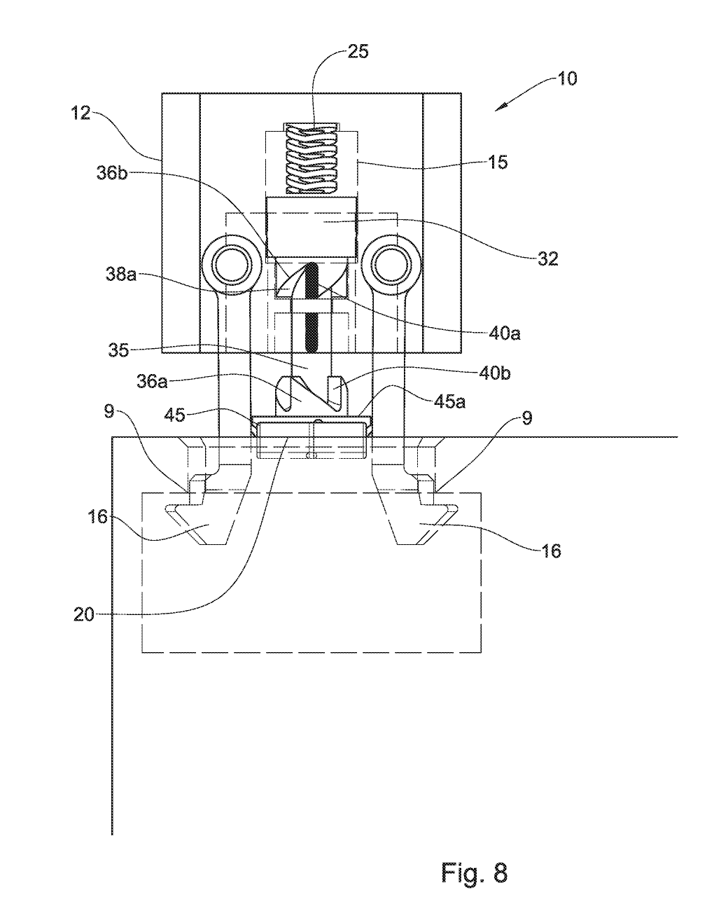

As shown in FIG. 8, further downward displacement of the container 5, allows further displacement of the follower 32 downwardly, such that the engagement of the first cam 22a with the slanted step 38a urges the follower to further rotate in the same direction as when second cam 22b engages with the slanted step 38b of the second guide 36b, i.e. a leftwards rotation. Thus, the ellipse plate 45, is further rotated as well, such that upon the completion of this step, i.e. when the first cam 22a is disposed at the end of the slanted step 38a engaging the longitudinal protrusions 40a, the ellipse plate 45 is rotated in another 45°.

As indicated by indication 46, as a result of the rotation of the ellipse plate 45, the minor axis 45b is transversely disposed with respect to a straight line between shoulder engaging portions 16, and the major axis 45a extends therebetween, such that the periphery of the ellipse plate 45 engages the shoulder engaging portions 16, and pushes them outwardly towards the shoulder portions 9 of the depression 8, against the force of the latches spring 20. Thus, following the rotation of the ellipse plate 45 the disposition of the shoulder engaging portions 16 is such that the imaginary encircling diameter of both of them together is larger than that of the opening 8a of the depression 8, and is substantially the same as the diameter of the two shoulder portions 9. Since in this position, the container is slightly lowered with respect the housing 12, the shoulder engaging portions 16, in this position, are located adjacent the shoulder portion 9 of the depression 8. As a result, the shoulder engaging portions 16 are in the secured position thereof, securing thereby the container 5 to the ceiling.

It is appreciated that the locking member can include only one securing latch provided with a shoulder engaging portion and configured to pivot sidewardly towards a shoulder portion of the container in response to a rotation of the ellipse plate as described herein above.

In this position, the follower 32 is back to its original longitudinal position with respect to the housing 12, and the spring 25 is in its maximum projected state.

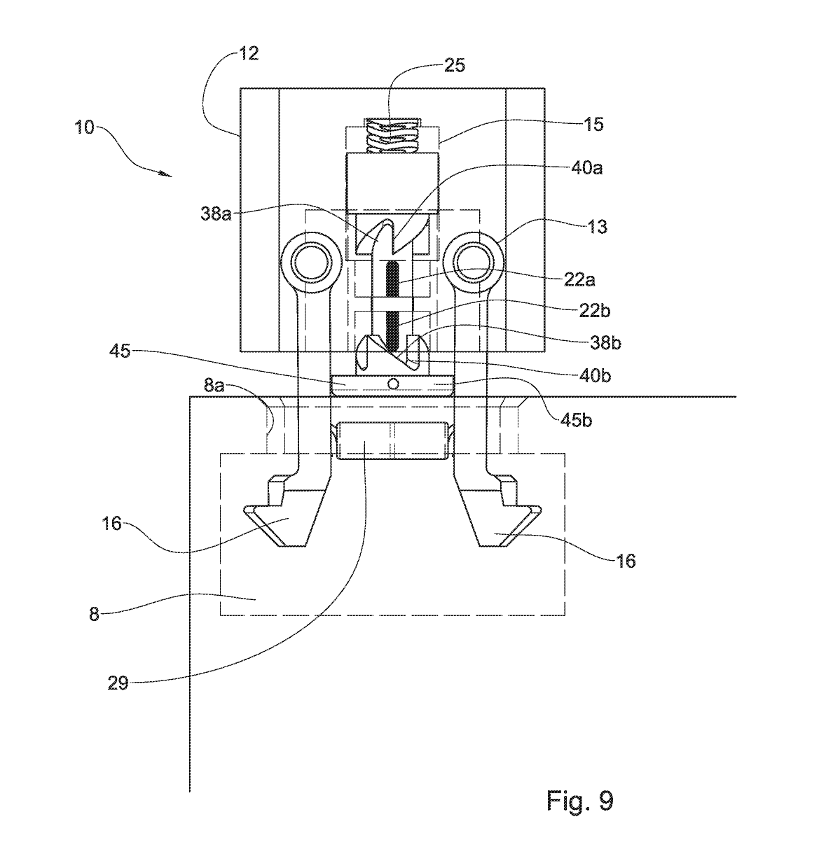

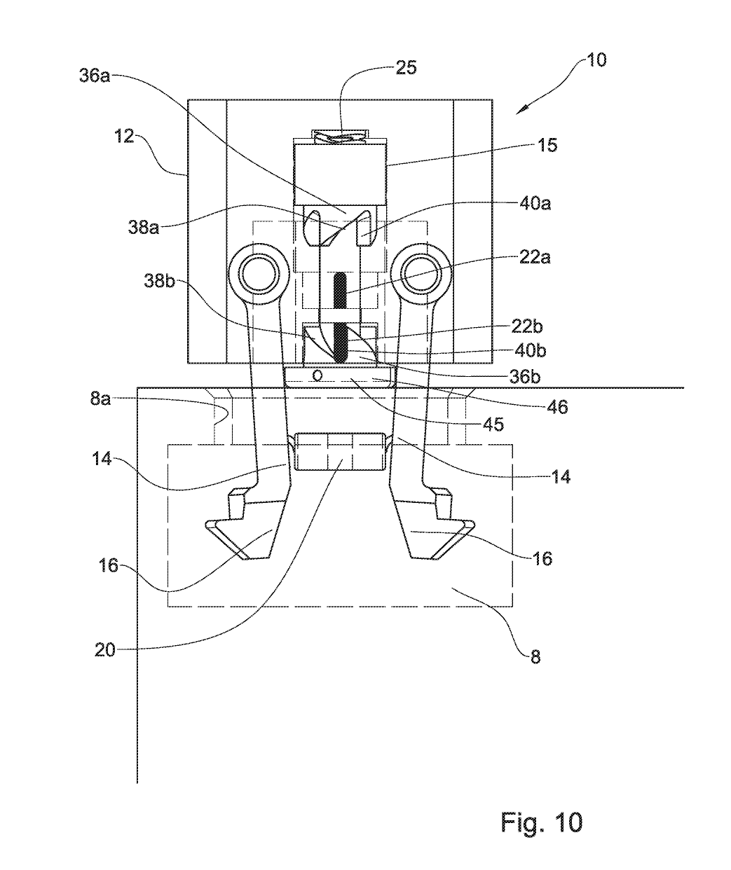

As illustrated in FIGS. 9 through 13, releasing the container 5 is carried out in the same fashion as securing thereof. That is to say, the container 5 is pushed upwardly, such that the shoulder engaging portions 16 disengage the shoulder portion 9 of the depression 8. As the container upper face engages the ellipse plate 45, the follower 32 is urged upwardly against the force of the spring 25. Further upward displacement of the container 5 brings the follower 32 to a disposition such that the second cam 22b engages the second guide 36b (FIG. 9), resulting in a rotation of the follower (FIG. 10).

As the follower 32 reaches its uppermost position inside the compartment 15, the container 5 can no longer be pushed upwards, and the second cam 22b engages the longitudinal protrusion 40b of the second guide 36b.

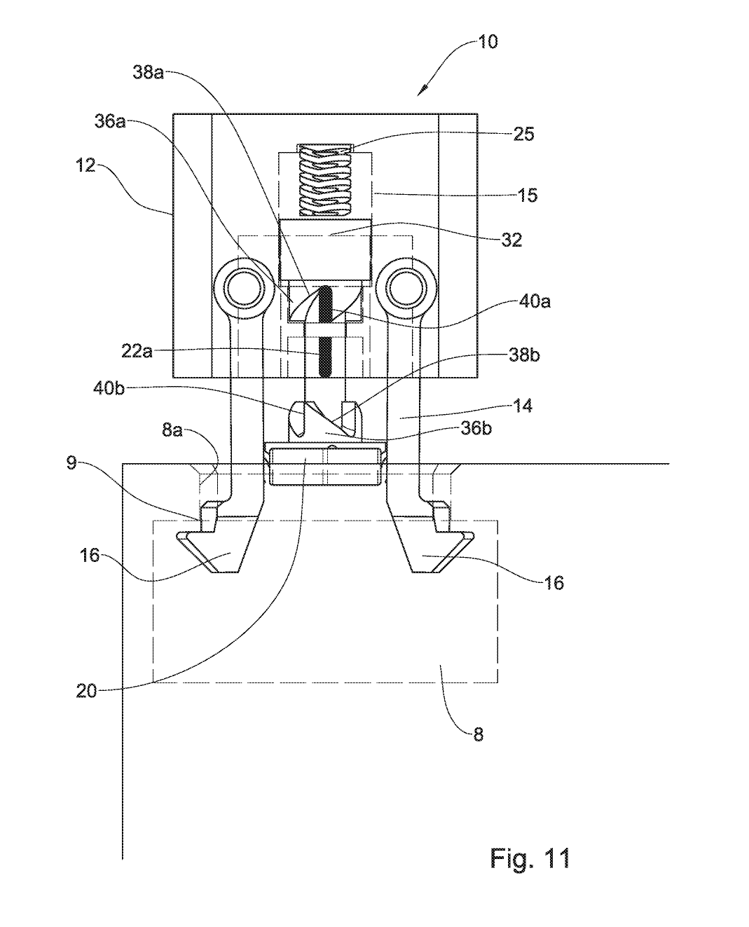

Lowering the container 5 back allows the follower 32 to be urged downwardly by the forces of the spring 25 allowing thereby the engagement of the first cam 22a with the first guide 36a of the follower 32, which is further then rotated (FIG. 11).

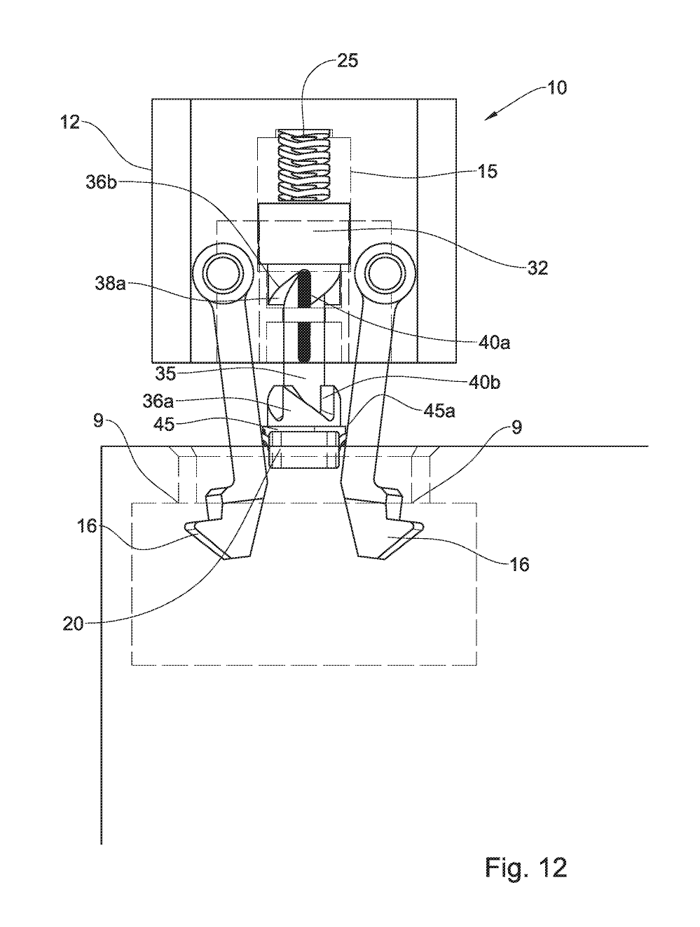

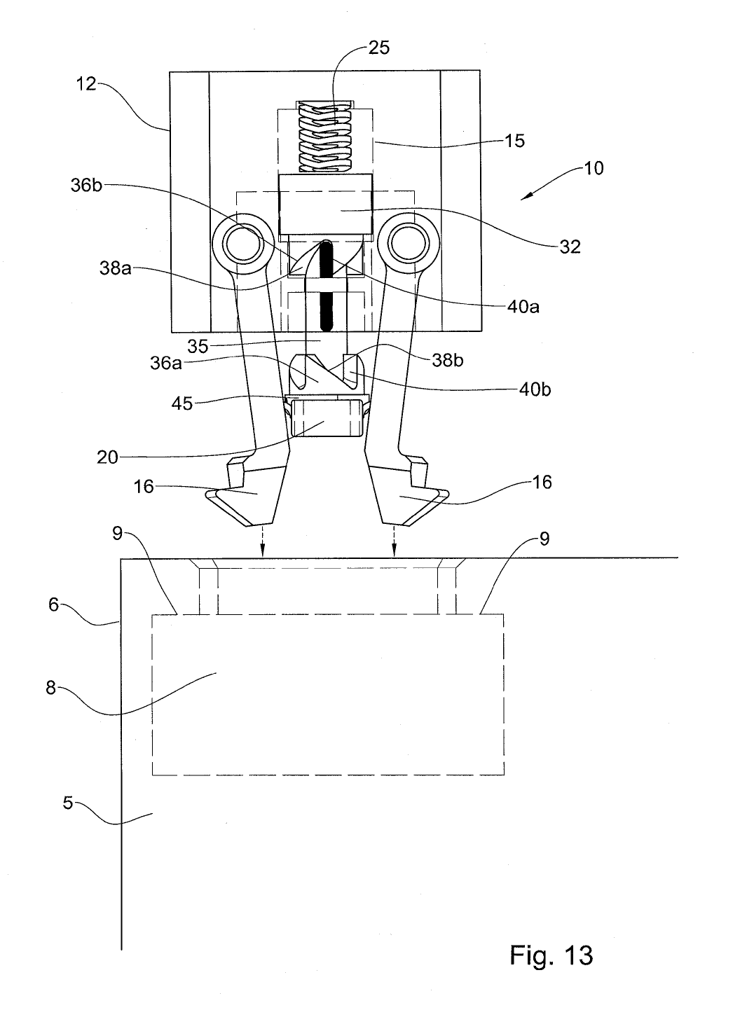

Rotation of the follower 32 causes the rotation of the ellipse plate 45 such that the major axis 45a thereof is no longer disposed in parallel to the line between the shoulder engaging portions 16. Thus, the ellipse plate 45 allows the shoulder engaging portions 16 to be urged back by the latches spring 20 to the released position thereof in which the imaginary encircling diameter of both of them is reduced. Further lowering of the container 5, allows the engagement of the first cam 22a with the longitudinal protrusion 40a of the first guide 36a (FIG. 12). In this position, the ellipse plate 45 is fully rotated such that the minor axis 45b thereof is transversely disposed with respect to the line between the shoulder engaging portions 16. Thus, the ellipse plate no longer urges the shoulder engaging portions 16 away from one another allowing them to be pulled towards one another by the latches spring 20. In this position, the imaginary encircling diameter of the shoulder engaging portions 16 is smaller than the diameter of the opening 8a of the depression 8, and the container 5 can be further lowered until the shoulder engaging portions 16 are out of the depression (FIG. 13).

It is appreciated that the securing mechanism of the presently disclosed subject matter can be mounted to a ceiling of a container's storage building, such as disclosed for Example in WO 2011/104716. Autonomous guided vehicles can be used to lift the containers towards the ceiling so as to bring the corner fitting thereof to a securing engagement with the securing mechanism such that the container is suspended from the ceiling. Releasing the container can be carried out by the autonomous guided vehicles pushing the container upwards thereby bringing the securing mechanism to the released position thereof. Thus, the apparatus of the presently disclosed subject matter can be utilized to hang containers from the ceiling thereby allowing the autonomous guided vehicles to travel around the building and underneath the hung containers so as to reach the desired container without having to remove other containers from their location.

It is further appreciated that that the locking member can be a rounded member mounted to the follower and configured to rotate therewith. The rounded member can include one or more locking elements protruding outwardly from along one dimension of the rounded member, and configured to engage a shoulder portion of another body, such as a container. This way, the locking member can be selectively disposed in a secure position wherein the locking element extends toward the shoulder portion or in a released position wherein the rounded member is rotated and the locking elements extends in a direction other than towards the shoulder portion. It is appreciated that the opening of the depression according to this example is such which allows introducing the rounded member and the locking elements when the latter is disposed in the released position.

It is further appreciated that the follower can be configured with a continuous slanted groove defined along the circumference thereof. The cam follower mechanism can include a cam member which is configured to slide along the path of the groove and configured to urge the rotation of the follower in response to a linear displacement thereof.

Those skilled in the art to which the presently disclosed subject matter pertains will readily appreciate that numerous changes, variations, and modifications can be made without departing from the scope of the invention, mutatis mutandis.

1-38. (canceled)

39. A securing mechanism for securing thereto a load, the securing mechanism comprising:
a locking member having at least one planner with a peripheral shape; and
a cam follower mechanism having a follower with a load facing end and being configured to translate a linear displacement along an axis being substantially perpendicular to the load facing end to a rotational movement thereof about the axis, and being so disposed relative to the locking member such that the rotational movement thereof sequentially shifts the locking member between a released position in which at least one dimension of the peripheral shape has a first size and a secured position in which the at least one dimension has a second size, the second size being larger than the first size.

40. The securing mechanism according to claim 39, wherein the locking member includes a pair of pivoting securing latches each having an engaging portion, wherein the at least one planner includes a planner encircling the engaging portion of the securing latches together.

41. The securing mechanism according to claim 40, wherein the engaging portion includes a shoulder engaging portion.

42. The securing mechanism according to claim 41, wherein the locking member includes a housing and wherein the securing latches are pivotally mounted in the housing.

43. The securing mechanism according to claim 42, wherein, in the secured position, the securing latches are configured to be pivoted away from one another such that the shoulder engaging portions are laterally displaced to thereby increase the size of the at least one planner encircling the engaging portion.

44. The securing mechanism according to claim 43, wherein the locking member includes a retracting mechanism configured to urge the shoulder engaging portions towards one another.

45. The securing mechanism according to claim 42, wherein at least a portion of the follower is slidably mounted within the housing.

46. The securing mechanism according to claim 45, wherein the follower includes a generally cylindrical member having at least one guide defining a slanted path along a portion of a circumference thereof, and the housing includes a cam segment defined therein and configured to slide along the slanted path such that in response to the linear displacement the follower is rotated.

47. The securing mechanism according to claim 40, wherein the follower includes an ellipse plate mounted thereon and having a major axis extending along a large diameter thereof and a minor axis extending along a small diameter thereof, wherein the at least one planner includes a planner encircling the engaging portion of the securing latches together with the ellipse plate mounted therebetween.

48. The securing mechanism according to claim 47, wherein the ellipse plate is mounted on the follower such that the orientation of the minor axis and the major axis is changed in response to a rotational movement of the follower.

49. The securing mechanism according to claim 48, wherein the ellipse plate is configured for 90° rotation in response to an upward displacement of the follower followed by a downward retraction with respect to the housing.

50. A locking apparatus for securing a load to a structure, the locking apparatus comprising:
a housing mountable to a structure; and
a retractable member having a load facing end coupled to a locking member including at least one planner having a peripheral shape;
wherein the load facing end of the retractable member is configured for sequentially shifting the locking member between a released position and a secured position in response to an upward displacement thereof followed by a downward retraction with respect to the housing;
wherein, in the released position, at least one dimension of the peripheral shape has a first size and, in the secured position, the at least one dimension has a second size.

51. The locking apparatus according to claim 50, wherein the retractable member includes a cam follower mechanism.

52. The locking apparatus according to claim 51, wherein the locking member includes an ellipse plate and at least one securing latch pivotally mounted to the housing and having an engaging portion wherein the at least one planner includes a planner encircling the engaging portion and the ellipse plate of the securing latch together.

53. The locking apparatus according to claim 52, wherein the engaging portion includes a shoulder engaging portion.

54. The locking apparatus according to claim 53, wherein the locking member includes two securing latch pivotally mounted to the housing, and wherein in the secured position the securing latches are configured to be pivoted away from one another such that the shoulder engaging portions are laterally displaced thereby increasing the size of the at least one planner encircling the engaging portion.

55. The locking apparatus according to claim 50, wherein the load facing end includes an ellipse plate mounted having a major axis extending along a large diameter thereof and a minor axis extending along a small diameter thereof.

56. The locking apparatus according to claim 55 wherein the ellipse plate is mounted on the follower such that the orientation of the minor axis and the major axis is changed in response to a rotational movement of the follower.

57. A locking assembly, comprising:
a body having a depression and a shoulder portion defined therein; and
a locking apparatus for securing to the body;
wherein the locking apparatus includes:
a locking member having at least one planner with a peripheral shape; and
a cam follower mechanism having a follower with a load facing end and being configured to translate a linear displacement along an axis substantially perpendicular to the load facing end to a rotational movement thereof about the axis, and being so disposed relative to the locking member such that the rotational movement thereof sequentially shifts the locking member between a secured position in which the locking member securely engages the shoulder portion and a released position in which the locking member disengages the shoulder portion.

58. The locking assembly of claim 57 wherein the depression is configured to allow introducing therein the locking member only in the released position thereof.
